(19) United States
(12) Patent Application Publication
(10) Pub. No.: US 2008/0042503 A1
(43) Pub. Date: Feb. 21, 2008

(54) ELECTRIC MOTOR

(76) Inventors: Hans-Walter HARTKORN, Munchen (DE); Roland Kienzler, Triberg-Nussbach (DE); Frank Mauch, Emmingen/Liptingen (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/837,797

(22) Filed: Aug. 13, 2007

(30) Foreign Application Priority Data
Aug. 15, 2006 (DE) 20 2006 012 901.4
Jun. 4, 2007 (EP) 07 010 942.6

(51) Int. Cl. H02K 5/16

(52) U.S. Cl. 310/90

(57) ABSTRACT

An electric motor has a housing with at least two housing parts (24, 86), within which a stator (82) is arranged. The motor further includes an internal rotor (38) mounted on a shaft (34), the rotor interacting with the stator (82) and being separated from it by an air gap (88). The shaft (34) is rotatably supported in the housing by roller bearings (30, 72). A first one (30) of the roller bearings has an inner ring (32) secured at a first predetermined position on the shaft (34), and an outer ring (28) secured in a recess (26) of a first housing part (24). A second one (72) of the roller bearings has an inner ring (70) secured at a second predetermined position on the shaft (34) and an outer ring (74) arranged in an associated recess (96) of a second housing part (86). The second roller bearing (76) is urged, by an ondular washer (98) in said recess (96), axially in the direction of the first roller bearing (30) when the first housing part (24) and the second housing part (86) are assembled together.

### CROSS-REFERENCES

This application claims priority from our German application DE 20 2006 012 901.4, filed 15 Aug. 2006, and from our European application 07 010 942.6, filed 4 Jun. 2007, the entire contents of which are hereby incorporated by reference.

### FIELD OF THE INVENTION

The present invention relates generally to an electric motor having a stator mounted in a housing thereof, and an internal rotor mounted on a shaft, magnetically interacting with the stator across an air gap and, more particularly, to an improved arrangement for supporting the shaft in the housing by means of roller bearings.

### BACKGROUND

Motors of this kind often need to satisfy special requirements, which result from the kind of device they are to drive, and these requirements tend to make the assembly of the bearings more difficult.

### SUMMARY OF THE INVENTION

Therefore, it is an object of the invention to provide an improved motor structure, which reduces the difficulty of assembling the motor and its bearings.

According to a first aspect of the invention, the rotor shaft is supported in the housing by a plurality of roller bearings. A first roller bearing and a second roller bearing each have a respective inner ring mounted in a predetermined position along the rotor shaft, and a respective outer ring which fits within a recess in a respective part of a two-part housing. This facilitates inserting the outer ring of the second roller bearing, from within, into the associated recess in the second housing part, and enables a cost-effective assembly process.

According to a further aspect of the invention, an ondular washer is arranged against an axial endface of the second roller bearing, to urge it toward the first roller bearing, a springy part of the washer being compressed or tensioned by a movement during assembly which axially displaces the second roller bearing with respect to its associated recess, defined in the second housing part.

### BRIEF FIGURE DESCRIPTION

Further details and advantageous refinements of the invention will be apparent from the following description and accompanying drawings of exemplary embodiments, which are not to be understood as limiting the invention.

FIG. 1 illustrates a motor module with a housing part 24 in which a hollow shaft 34 is rotatably supported, the shaft forming part of an internal rotor;

FIG. 2 is a section, along lines II-II of FIG. 1, shown greatly enlarged;

FIG. 3 is a longitudinal section through the structure of FIG. 1, connected to a second module 26, in which the external stator 92 of the motor is secured, to work together with the internal rotor 38 of FIG. 1;

FIG. 4 is an enlarged detail (rotated 90 degrees) of the FIG. 3 structure, according to which a so-called sinuous spring or ondular washer 98 is arranged between a bearing and one wall of its associated recess, the spring having been treated so that it has increased friction, at least on its engagement surfaces;

FIG. 5 illustrates a variant of FIG. 4, in which an outer surface of the bearing and of an opposing abutment surface of the housing are each provided with a friction coating, in order to increase the friction between these friction coatings and both sides of an ondular washer 98 inserted there;

FIG. 6 illustrates a second variant, in which two annular washers are used, both sides of which are treated for increased friction, a first annular washer located between bearing 74 and an undulating washer 98 and the other located between undulating washer 98 and the associated recess 97 defined in the motor housing;

FIG. 7 illustrates a variant of the detail of FIG. 3;

FIG. 8 is a section, taken longitudinally along line VIII-VIII of FIG. 7, and

FIG. 9 is a perspective view of an elastomer ring 142 of FIG. 8.

### DETAILED DESCRIPTION

In the following description, the same reference numerals are used for identical or functionally equivalent parts, and these parts are generally only described once. The terms “left,” “right,” “top,” and “bottom” refer to the respective Figure.

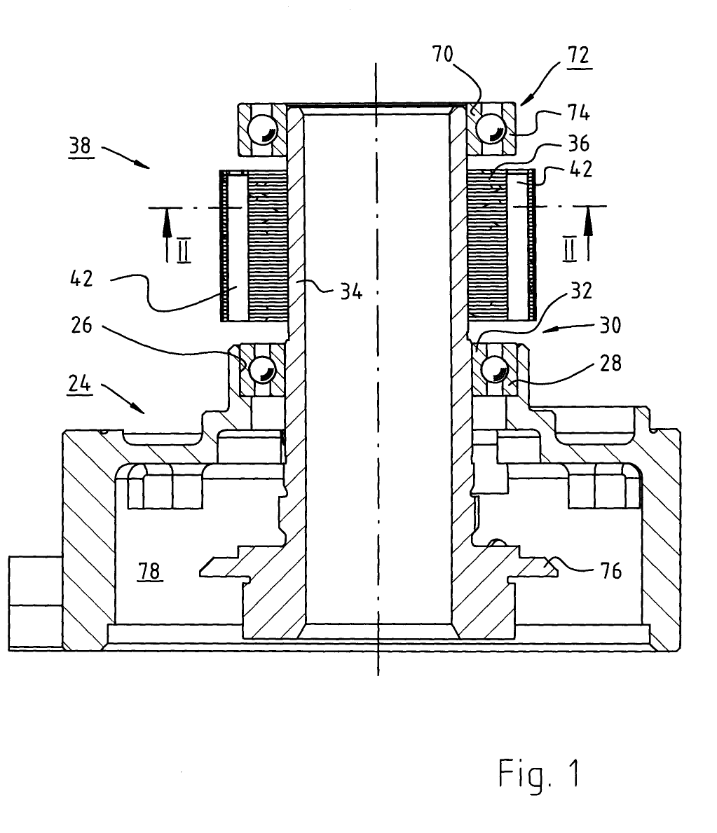

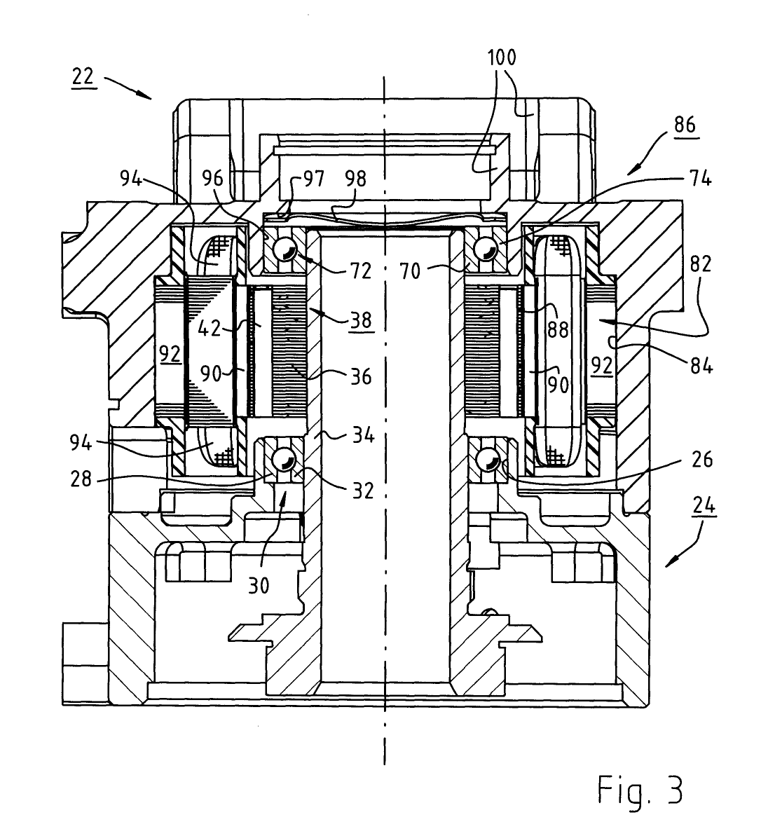

FIG. 1 illustrates, at an enlarged scale, the lower part 24 of an electronically commutated motor shown in FIG. 3. The motor has a first housing part 24, shaped essentially like an end shield, and formed with a recess 26, into which the outer ring 28 of a first roller bearing 30 is press-fitted. The inner ring 32 of first roller bearing 30 is pressed onto the outside of a hollow shaft 34 at a first predetermined position, i.e. the shaft is supported for rotation relative to the first housing part 24.

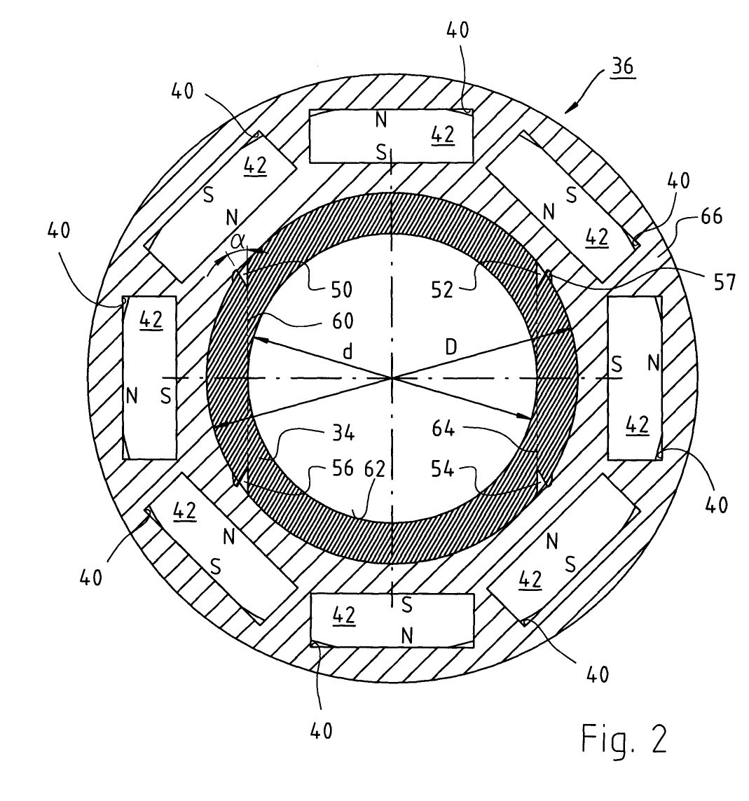

Onto the upper part of the shaft 34 shown in FIG. 1, the lamination stack 36 of an internal rotor 38 is pressed, the rotor having eight pockets 40 therein as shown in FIG. 2. In these are located a total of eight permanent magnets 42 which are, in the manner shown, radially magnetized, i.e. the internal rotor 38 is, in this embodiment, eight-poled. Clearly a different number of poles is possible, depending upon the intended use of the motor. Magnets 42 have, on their radially outer surface, an essentially roof-shaped profile, which facilitates their insertion into the pockets 40, and which can favorably influence the course of the magnetic flux density at the outside 46 of the internal rotor 38. One strives in most cases for a sinusoidal course of this magnetic flux density in order, in conjunction with sinusoidal stator currents, to obtain an essentially constant torque in such a motor. One thus often refers to a “sinus motor.”

As FIG. 2 shows, the hollow shaft 34 has four longitudinally extending notches 50, 52, 54, 56 which are cross-sectionally essentially triangular in the embodiment shown. Treating the shaft as a clockface, they are preferably at approximately the following places:

| | |
|---|---|
| Notch 50 | 10 o'clock |
| Notch 52 | 2 o'clock |
| Notch 54 | 4 o'clock |
| Notch 56 | 8 o'clock. |

The notches 50 and 56 are aligned with each other. A line 60, drawn along their inner faces, preferably extends approximately tangent to the inner surface 62 of hollow shaft 34. The same applies for a line 64 which connects the notches 52 and 54. The inner faces of notches 50, 56 coincide with line 60 and the inner faces of notches 52, 54 coincide with line 64. Lines 60, 64 extend essentially parallel to each other. The notches 50 through 56 each define, as shown, an acute angle α, and forming them causes a material-excess 57 to be pressed outward as shown which, during pressing-on of the lamination stack 66, creates a particularly good and durable connection between the stack and the hollow shaft 34. Further, the magnetic circuit for the flux of permanent magnets 42, which runs partly through the lamination stack 36, and partly through shaft 34, is improved.

As FIG. 1 shows, above internal rotor 38, at a second predetermined position on the hollow shaft 34, the inner ring 70 of a roller bearing 72 is pressed on. The outer diameter of roller bearing 72 is smaller than the outer diameter of internal rotor 38. Roller bearing 72 has an outer ring 74.

As shown in FIG. 1, the lower portion of hollow shaft 34 is formed with a flange 76 which cooperates with a device (not shown) for detecting the rotational orientation of internal rotor 38. For this purpose, the first housing part 24 has an annular space 78, in which the electronic components (not shown) of motor 22 can be arranged. Alternatively, these could be arranged outside the motor.

As FIG. 3 shown, the internal rotor 38 is, together with hollow shaft 34, inserted into an external stator 82, secured on the inner face 84 of a second housing part 86. In the assembled state, that stator is separated from internal rotor 38 by a cylindrical air gap 90. The external stator has, in this embodiment, twelve salient poles 90. On it, there is a three-phase winding, connected for example in star configuration. The magnetic return path of stator poles 90 is designated 92. Stator 82 is, like internal rotor 38, formed of laminations. FIG. 3 illustrates end turns 94 of the stator windings.

For receiving the outer ring 74 of second roller bearing 72, the second housing part 86 is formed with an associated recess 96, whose upper end is designated in FIG. 3 with numeral 97.

Into this associated recess 96, during the assembly process, one inserts the outer ring 74 of second roller bearing 72. Thereby, an ondular washer 98, located between outer ring 74 and the upper end 97 of recess 96, becomes compressed, and the two roller bearings 30 and 72 are thereby placed under tension or biased with respect to each other, i.e. urged toward one another.

The ondular washer 98 also increases the friction between the outer ring 74 and the associated recess 96, which is desirable, in order to prevent the outer ring 74 from rotating.

If the roller bearing 72, to which the stationary outer ring 74 belongs, turns, a frictional torque is created, which tends to cause the ring 74 to turn within recess 96. The magnitude of this frictional torque is a function of:

the general manufacturing tolerance of the roller bearing used,

the bearing's structure type,

the bearing tolerance,

the prestress effective between the inner & outer rings of the bearing,

the kind of lubrication in the bearing, and

the eddy currents which arise in the bearing during operation and which heat it up.

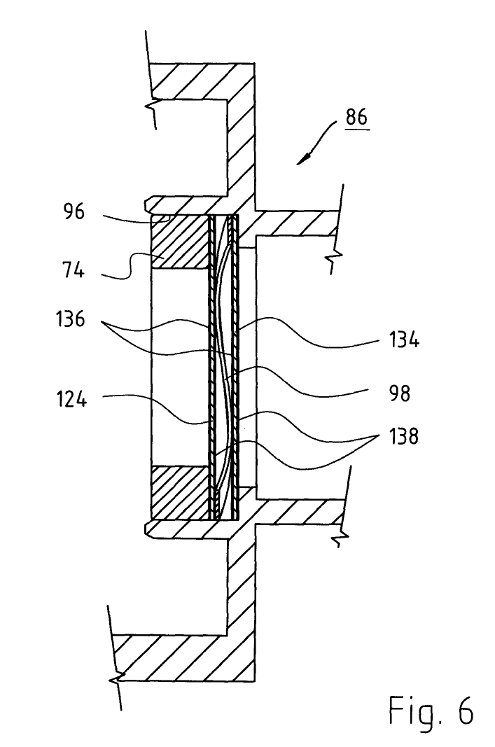

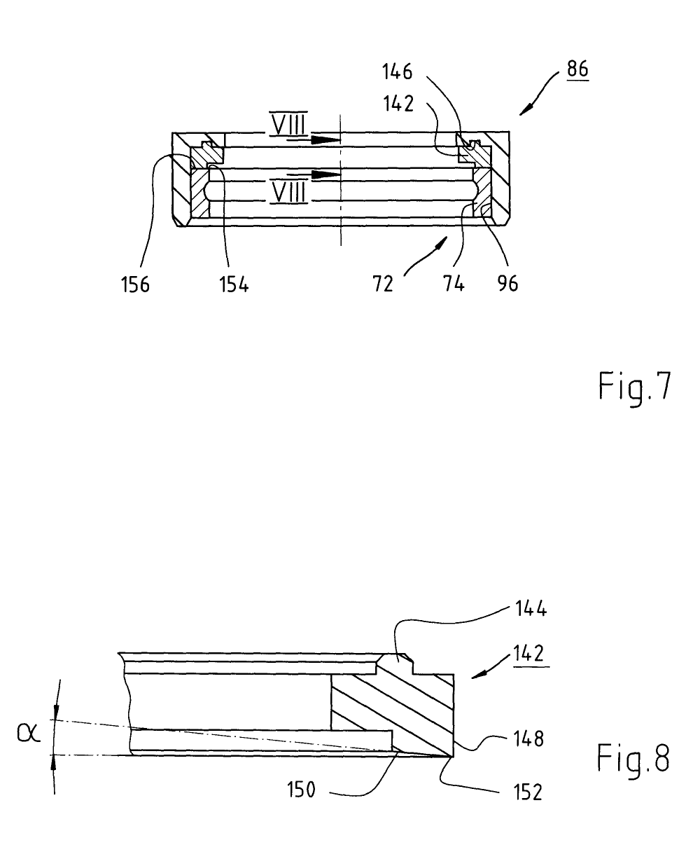

This frictional torque is counteracted by a clamping-friction torque whose magnitude is caused by the biasing force exerted by ondular washer 98, which is effective between the outer ring 74 and the second housing part 86 and between the outer ring 74 and the washer 98 or—in FIG. 6—between outer ring 74 and an annular washer 124 or—in FIG. 7—a clamping-friction torque generated by the clamping force of an elastomer ring 142, effective between the outer ring 74 and the second housing part 86.

If the frictional torque, arising during rotation, effective upon the outer ring 74, ever has a magnitude greater than that caused by the clamping, the outer ring 74 will rotate within recess 96.

For this reason, within the scope of the present invention, various means can be employed, all of which are intended to increase the clamping-friction torque and/or raise the friction coefficient μᵣ.

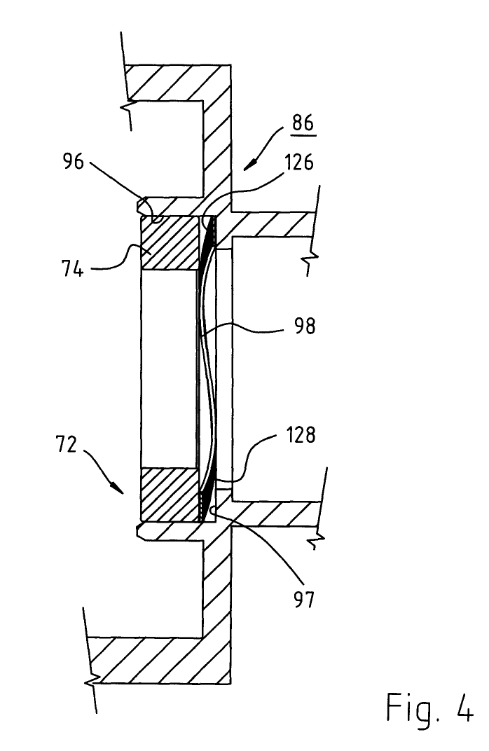

According to FIG. 4, on both sides of ondular washer 98, the surfaces 126 (left) and 128 (right), shown black in FIG. 4, are treated or altered to increase their frictional torque. For this, there are various possibilities: for example, at least one of the surfaces 126, 128 can be coated with a layer which increases the friction, e.g. with a thin layer of elastomeric material such as tetraphenyl ethene or TPE=(C6H5)2C═C(C6H5)2 or of lacquer containing elements which increase friction, like sandpaper or emery paper. Also, at least one of the surfaces 126, 128 can be roughened, or it can be textured with depressions or grooves or pointy projections. It would suffice to provide these alterations of the surfaces just where the washer 98 contacts the outer ring 74 or the surface 97, i.e. only in predetermined areas. A coating with a material having adhesive characteristics is also possible, e.g. using a pressure-sensitive adhesive.

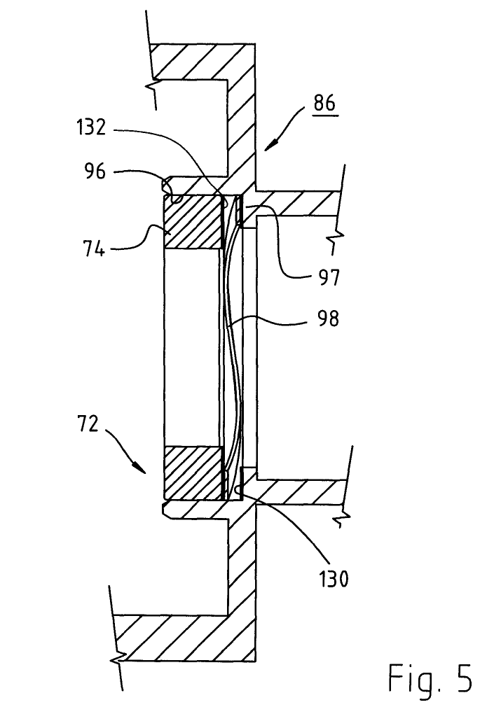

Alternatively, according to FIG. 5, a standard ondular washer 98 without coating can be used, and instead a corresponding alteration of the opposing surface 130 of face 97 and of the opposing surface 132 of outer ring 74 can be undertaken, i.e. coating, mechanical roughening, or the like.

According to FIG. 6, one can use special annular washers 124, 134 in conjunction with a standard ondular washer 98. The washers 124, 134 are identical. On the left, they have a surface alteration 136, and on the right, a surface alteration 138 of the kind described above, e.g. coating with an elastomer having a high friction coefficient, lacquering with a substance analogous to emery paper, roughening of surfaces 136, 138 in the manner described, coating in a dipping tank, coating with a pressure-sensitive adhesive, etc.

During assembly, the second housing part 86 and the first housing part 24 interengage with each other as shown in FIG. 3, center or align with each other, and are coupled together using assembly bolts (not shown). The upper end of second housing part 86 has an opening 100, through which the hollow shaft 34 can be directly connected to an element to be driven, e.g. the drive of a blind or shutter.

FIG. 7 illustrates a variant of FIG. 3 for the axial biasing of outer ring 74 of roller bearing 72 within recess 96. For this purpose, this variant uses a ring 142 made of a suitable elastomer. Ring 142 has, on its upper side as seen in FIG. 7, an annular projection 144 (FIG. 8) which, in an assembled state, engages into an annular groove 146 (FIG. 7) of housing part 86, and thereby is centered within recess 96 and held there.

Ring 142 has a cylindrical outer face 148, with which it is guided in housing part 86, and has, on its underside, a frusto-conical annular shoulder 150 whose included angle α approximates, e.g., 5 degrees, as the (imaginary) diverging lines of the cone indicate. This shoulder 150 abuts, with its radially outer rim 152 (FIG. 8), against the radially outer rim 156 (FIG. 7) of the upper side 154 of bearing outer ring 74.

The remaining structure is identical to that of FIG. 3. Due to the deformation of elastomeric ring 142 during assembly, a corresponding force on the upper side 154 of bearing ring 74 is created.

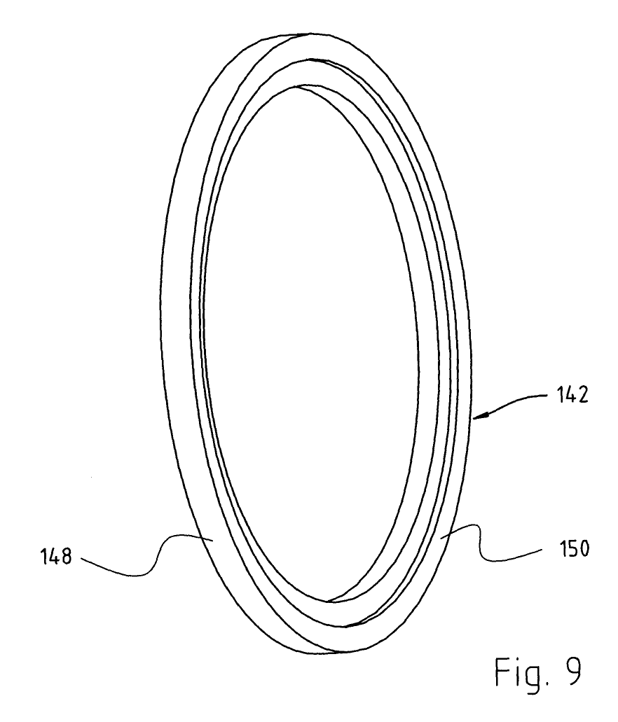

In this, it is immaterial whether side 150 of ring 142 is frusto-conical, and the upper side 154 of the bearing ring is untapered, or conversely, side 150 is untapered, and the upper side 154 frusto-conical, as shown in FIG. 7. An important feature is that, just as in the FIG. 3 structure, a biasing force on the bearings 30, 72 is created, which assures smooth running, and keeps outer ring 142 from rotating within recess 96. FIG. 9 shows a preferred embodiment of elastomeric ring 142, in perspective.

Naturally, within the scope of the present invention, many variations and modifications are possible, and these can also be combined with each other, depending upon the requirements of the intended use.

What is claimed is:

1. An electric motor comprising:
a housing having at least two parts (24, 86);
a stator (82) mounted in said housing;
an internal rotor (38) mounted on a shaft (34), said rotor magnetically interacting, in operation, with said stator (82) across an air gap (88) defined therebetween;
a plurality of roller bearings (30,72) rotatably supporting said shaft (34) within said housing (24, 86), a first one of said roller bearings having an inner ring and an outer ring, and having its inner ring (32) secured at a first predetermined position on said shaft (34) and its outer ring (28) secured in a first recess (26) formed in a first part (24) of said housing;
a second one (72) of said roller bearings also having an inner ring (70) and an outer ring (74), and having its inner ring (70) secured at a second predetermined position on said shaft (34) and its outer ring (74) arranged in a recess (96) formed in a second part (86) of said housing; and
a spring (98, 142) is arranged in said recess (96) in said second part (86) of said housing, to urge the outer ring (74) of said second roller bearing (72) axially toward said first roller bearing (30) when said first housing part (24) and said second housing part (86) are coupled to each other.

2. The electric motor of claim 1, wherein
said second roller bearing (72) has an outer diameter no greater than the outer diameter of said internal rotor (38).

3. The electric motor of claim 1, wherein
said spring (98, 142) is an ondular washer (98) which abuts against an end face, remote from the first roller bearing (30), of the outer ring (74) of the second roller bearing (72) and which spring is compressed by a movement arising during assembly, in order to urge said outer ring (74) of said second roller bearing to move relative to the associated recess (96) of the second housing part (86).

4. The electric motor of claim 1, wherein
said shaft (34) is formed as a hollow shaft.

5. The electric motor of claim 4, wherein
the hollow shaft (34) has a segment having a predetermined inner diameter (d) and a predetermined outer diameter (D), on which a plurality of longitudinally extending grooves or notches (50, 52, 54, 56) are formed, spaced about a circumference of the shaft segment, a distance between adjacent pairs (50, 52; 54, 56) of said notches being at least as large as said inner diameter (d) but smaller than said outer diameter (D) of said shaft segment.

6. The electric motor of claim 5, wherein
at least one notch has a side face which coincides with an imaginary plane (60) drawn through said shaft, connecting a pair of notches.

7. The electric motor of claim 5, wherein at least one notch has a side face which defines an acute angle (α) with an imaginary plane (60) drawn through a pair of adjacent notches (50, 56).

8. The electric motor of claim 5, wherein
a plurality of points (57) of shaft material project adjacent to sides of said notches (50, 52, 54, 56), and
upon press-fitting of said internal rotor (36) onto said hollow shaft (34), said projecting points (57) engage with said rotor (36).

9. The electric motor of claim 5, wherein
an imaginary line (60) interconnecting a pair of notches (50, 56) runs essentially tangent, to an inner surface (62) of said hollow shaft (34), at a point intermediate said pair of notches.

10. The electric motor of claim 9, wherein
side surfaces, of said pair of notches (50, 56) closest to an axis of said shaft (34), essentially coincide with a plane which includes said imaginary line (60).

11. The electric motor of claim 10, wherein
said notches (50, 56) each have a side surface which forms an acute angle (α) with respect to said plane including said imaginary line (60).

12. The electric motor of claim 4, wherein
said hollow shaft (34) has an outer surface and an inner surface which are essentially concentric with respect to each other.

13. The electric motor of claim 1, further comprising
a friction element (126, 128; 144, 146) arranged adjacent said spring (98; 142), and serving to increase a frictional torque between the outer ring (74) of said second roller bearing (72) and said second housing part (86).

14. The electric motor of claim 13, wherein
said spring (98, 142) has a surface treatment which increases a friction coefficient (μᵣ) on surfaces which contact at least one of said outer bearing ring (74) and an associated recess (96, 97; 146).

15. The electric motor of claim 14, wherein said spring (98, 142) is an ondular washer and is provided, at least locally, with a coating (126, 128) which increases its friction coefficient (μᵣ).

16. The electric motor of claim 14, wherein
a friction coefficient of said spring is elevated by mechanical surface treatment thereof.

17. The electric motor of claim 15, wherein
at least one of contact surfaces of
a spring-facing side of the outer bearing ring (74) and
a spring-facing side (146) of the recess (96) in said housing is provided with an elevated friction coefficient (μᵣ).

18. The electric motor of claim 13, further comprising, in the associated recess (96), at least one washer (124, 134), at least one (136) of whose surfaces has been altered to elevate its friction coefficient (μᵣ).

19. The electric motor of claim 13, further comprising
a coating (126) of elastomeric material applied to at least one of said recess (96), said ondular washer (98) and said outer bearing race (74) to elevate a coefficient of friction thereof.

20. The electric motor of claim 19, wherein
said elastomeric material contains tetraphenyl ethene (TPE).
